(19) United States
(12) Patent Application Publication
(10) Pub. No.: US 2006/0044785 A1
(43) Pub. Date: Mar. 2, 2006

(54) Solar lamp available for outdoor use

(76) Inventor: Feng-Nien Lee, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/929,060

(22) Filed: Aug. 30, 2004

(51) Int. Cl. F21V 33/00; F21V 23/04; F21V 5/00

(52) U.S. Cl. 362/96; 362/276; 362/559; 362/565

(57) ABSTRACT

A solar lamp includes a refraction light tube, a housing mounted on the refraction light tube, a light emitting member mounted on the housing to emit a light source outward through the refraction light tube, an optical sensing switch mounted on the housing and connected to the light emitting member, and a solar receiving board mounted on the housing. Thus, the solar lamp is portable and available for outdoor use, thereby facilitating a user carrying and operating the solar lamp. In addition, the solar lamp functions as a water sprayer, thereby enhancing the versatility of the solar lamp.

### BACKGROUND OF THE INVENTION

1. Field of the Invention

The present invention relates to a solar lamp, and more particularly to a portable solar-powered lamp available for outdoor use.

2. Description of the Related Art

A lamp is mounted in the house to provide an illuminating effect. However, the lamp is connected to a power supply by an electric wire, so that it is inconvenient for a user to mount the lamp outdoors, thereby causing inconvenience to the user.

### SUMMARY OF THE INVENTION

In accordance with the present invention, there is provided a solar lamp, comprising a refraction light tube having an inside formed with a plurality of air bubbles arranged in an irregular manner.

The primary objective of the present invention is to provide a portable solar-powered lamp available for outdoor use.

Another objective of the present invention is to provide a solar lamp, wherein the solar lamp is portable and available for outdoor use, thereby facilitating a user carrying and operating the solar lamp.

A further objective of the present invention is to provide a solar lamp, wherein the brightness of the light source from the light emitting member is enhanced by the refractive surface formed by the irregularly arranged air bubbles of the refraction light tube, so that the light emitting member only needs to provide a smaller power, thereby saving the electric energy of the solar lamp.

A further objective of the present invention is to provide a solar lamp, wherein the solar lamp functions as a water sprayer, thereby enhancing the versatility of the solar lamp.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a solar lamp in accordance with the preferred embodiment of the present invention;

FIG. 2 is a perspective view of a housing of the solar lamp as shown in FIG. 1;

FIG. 3 is a perspective assembly view of the solar lamp as shown in FIG. 1;

FIG. 4 is a schematic operational view of the solar lamp as shown in FIG. 3 in use;

FIG. 5 is a partially plan cross-sectional assembly view of a solar lamp in accordance with another embodiment of the present invention;

FIG. 6 is a perspective view of a solar lamp in accordance with another embodiment of the present invention; and

FIG. 7 is a perspective view of a solar lamp in accordance with another embodiment of the present invention.

### DETAILED DESCRIPTION OF THE INVENTION

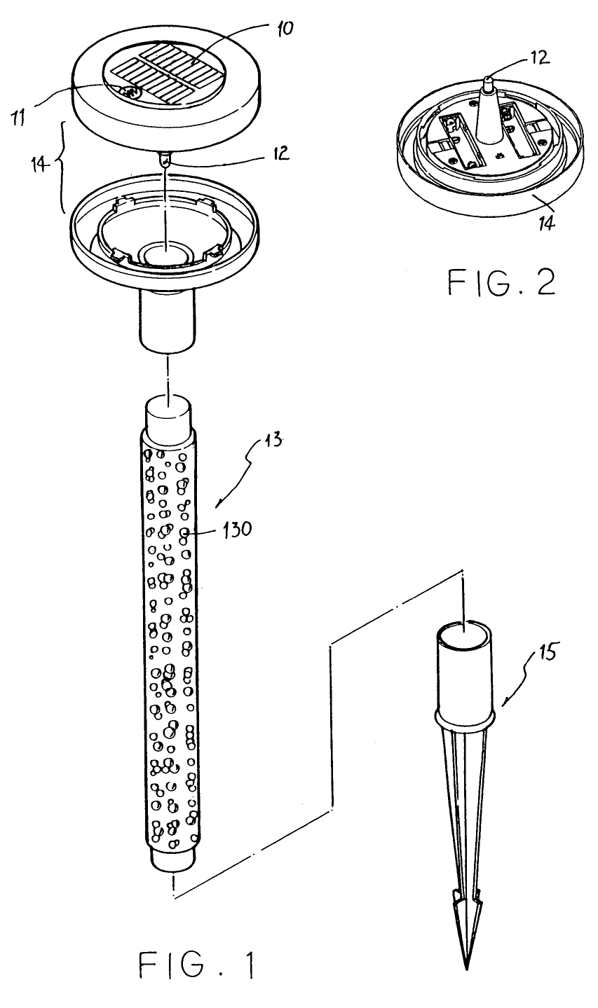

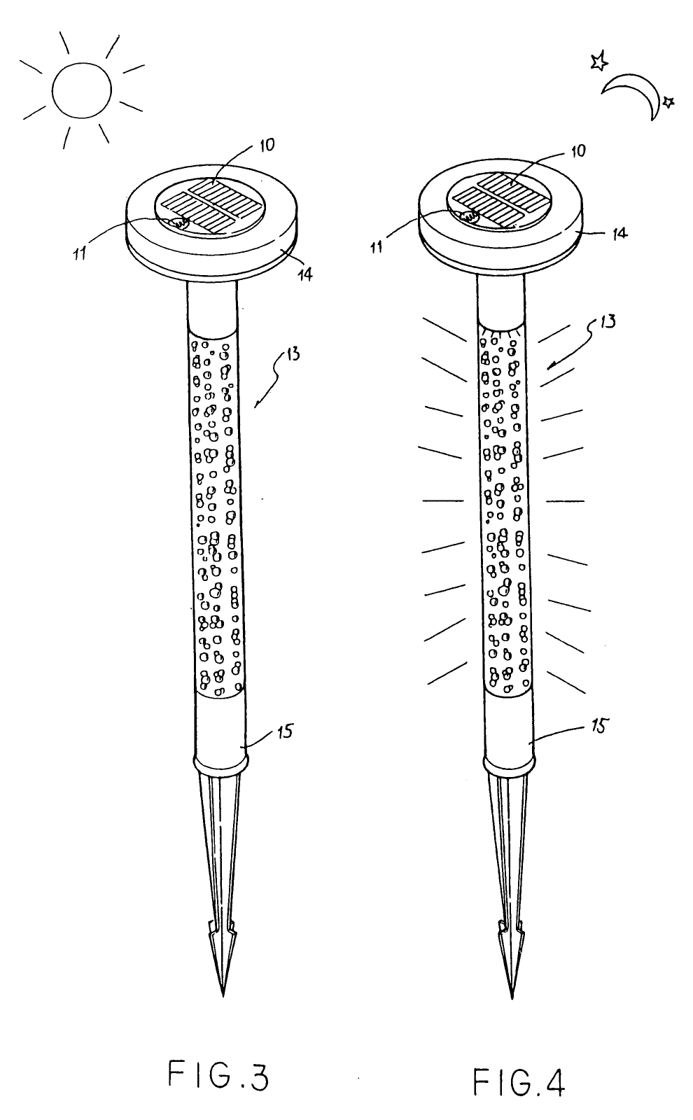

Referring to the drawings and initially to FIGS. 1-4, a solar lamp in accordance with the preferred embodiment of the present invention comprises a refraction light tube 13, a housing 14 mounted on the refraction light tube 13, a light emitting member 12 mounted on the housing 14 to emit a light source outward through the refraction light tube 13, an optical sensing switch 11 mounted on the housing 14 and connected to the light emitting member 12, and a solar receiving board 10 mounted on the housing 14.

The refraction light tube 13 is made of acrylic material and has an inside formed with a plurality of air bubbles 130. Preferably, the air bubbles 130 of the refraction light tube 13 are arranged on a surface of the refraction light tube 13 in an irregular manner to provide a larger arc-shaped optical refraction area so as to enhance the refractivity of the light source from the light emitting member 12. In such a manner, the weak light source from the light emitting member 12 is strengthened by the refractive surface formed by the irregularly arranged air bubbles 130 of the refraction light tube 13, thereby enhancing the brightness of the light source from the light emitting member 12, and thereby enhancing the aesthetic quality of the refraction light tube 13.

The housing 14 has a bottom mounted on a first end of the refraction light tube 13. The refraction light tube 13 has a second end formed with a wedge-shaped insert 15 to facilitate assembly of the refraction light tube 13 on the ground. Preferably, the light emitting member 12 is a light emitting diode and has an end face directed toward the first end of the refraction light tube 13. The solar receiving board 10 receives the solar energy to charge a battery (not shown) contained in the housing 14. A control circuit board (not shown) is mounted in the housing 14 and connected to the optical sensing switch 11 and the light emitting member 12 to control operation of the light emitting member 12.

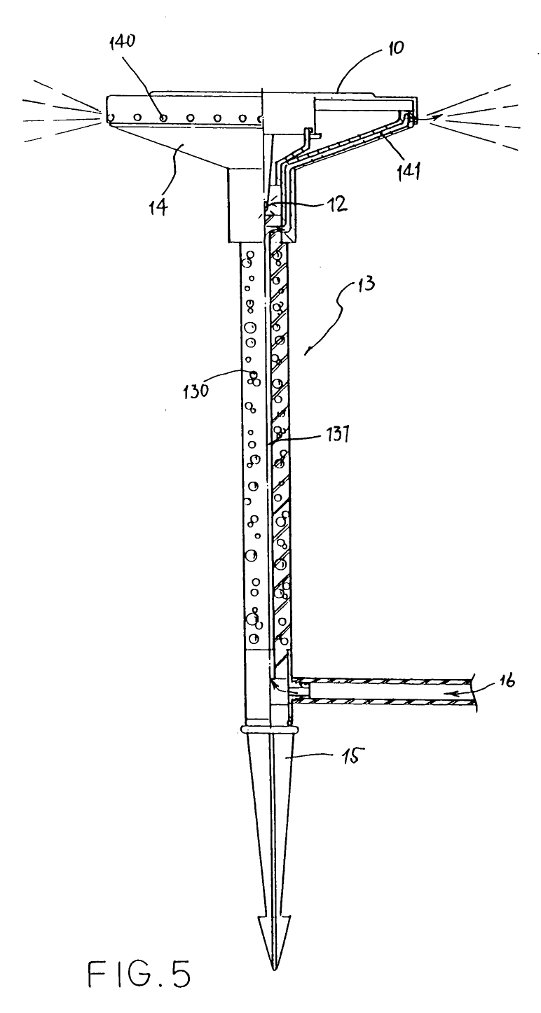

Referring to FIG. 5, the housing 14 has a surface provided with a plurality of nozzles 140 and has an inside formed with a water conduit 141 connected to each of the nozzles 140, and the inside of the refraction light tube 13 is formed with a water channel 131 having a first end connected to the water conduit 141 of the housing 14 and a second end connected to a water source 16, so that water from the water source 16 is introduced through the water channel 131 of the refraction light tube 13 and the water conduit 141 of the housing 14 into the nozzles 140 of the housing 14 and are sprayed outward from the nozzles 140 of the housing 14. Thus, the solar lamp functions as a water sprayer.

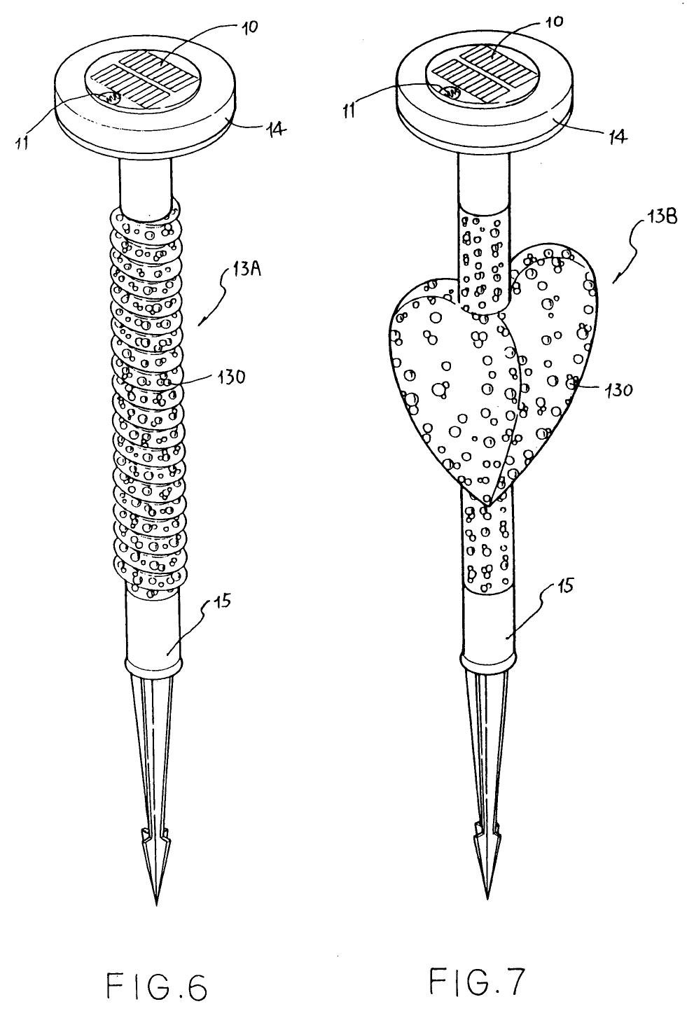

Referring to FIG. 6, the refraction light tube 13A has a corrugated surface.

Referring to FIG. 7, the refraction light tube 13B has a heart-shaped surface.

Accordingly, the solar lamp is portable and available for outdoor use, thereby facilitating a user carrying and operating the solar lamp. In addition, the brightness of the light source from the light emitting member is enhanced by the refractive surface formed by the irregularly arranged air bubbles of the refraction light tube, so that the light emitting member only needs to provide a smaller power, thereby saving the electric energy of the solar lamp. Further, the solar lamp functions as a water sprayer, thereby enhancing the versatility of the solar lamp.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A solar lamp, comprising a refraction light tube having an inside formed with a plurality of air bubbles arranged in an irregular manner.

2. The solar lamp in accordance with claim 1, wherein the air bubbles are arranged on a surface of the refraction light tube in an irregular manner to provide a larger arc-shaped optical refraction area so as to enhance the refractivity of the light source from a light emitting member.

3. The solar lamp in accordance with claim 2, wherein a light source from the light emitting member is strengthened by a refractive surface formed by the irregularly arranged air bubbles of the refraction light tube, thereby enhancing the brightness of the light source from the light emitting member.

4. The solar lamp in accordance with claim 1, wherein the refraction light tube is made of acrylic material.

5. The solar lamp in accordance with claim 1, further comprising a housing mounted on the refraction light tube.

6. The solar lamp in accordance with claim 5, wherein the housing has a bottom mounted on an end of the refraction light tube.

7. The solar lamp in accordance with claim 5, further comprising a light emitting member mounted on the housing to emit a light source outward through the refraction light tube, an optical sensing switch mounted on the housing and connected to the light emitting member, and a solar receiving board mounted on the housing.

8. The solar lamp in accordance with claim 7, wherein the light emitting member is a light emitting diode.

9. The solar lamp in accordance with claim 7, wherein the light emitting member has an end face directed toward an end of the refraction light tube.

10. The solar lamp in accordance with claim 1, wherein the refraction light tube has an end formed with a wedge-shaped insert to facilitate assembly of the refraction light tube on the ground.

11. The solar lamp in accordance with claim 5, wherein the housing has a surface provided with a plurality of nozzles and has an inside formed with a water conduit connected to each of the nozzles, and the inside of the refraction light tube is formed with a water channel having a first end connected to the water conduit of the housing and a second end connected to a water source.

12. The solar lamp in accordance with claim 1, wherein the refraction light tube has a corrugated surface.

13. The solar lamp in accordance with claim 1, wherein the refraction light tube has a heart-shaped surface.
